(19) United States
(12) Patent Application Publication
(10) Pub. No.: US 2006/0150681 A1
(43) Pub. Date: Jul. 13, 2006

(54) Glassware molds with cooling arrangement

(75) Inventor: Juan G. Giraldo, Holland, OH (US)

Correspondence Address: OWENS-ILLINOIS, INC., ONE SEAGATE, 25-LDP, TOLEDO, OH, 43666, US

(73) Assignee: Owens-Brockway Glass Container Inc.

(21) Appl. No.: 11/036,786

(22) Filed: Jan. 13, 2005

(51) Int. Cl. C03B 9/38; C03B 11/12

(52) U.S. Cl. 65/82; 65/83; 65/356

(57) ABSTRACT

A mold for a glassware forming machine includes a pair of mold segments each having a central portion and laterally spaced edge portions adapted to be brought together at the edge portions to form a mold cavity. A coolant shell is externally mounted over the central portion of each mold segment to form a cooling cavity between the coolant shell and the central portion of the mold segment, and the coolant shells do not extend into the edge portion of the mold segments. Coolant passages separate from the cooling cavities extend axially through the edge portions of the mold segments to facilitate cooling the edge portions in use.

### FIELD OF THE INVENTION

This invention relates generally to forming articles of glassware, and more particularly to a cooling arrangement for glassware forming molds.

### BACKGROUND OF THE INVENTION

Individual section (IS) glassware forming machines typically include one or more molds, each having separable mold sections, providing a plurality of mold cavities arranged side-by-side. To facilitate cooling the molds it is known to provide cooling channels about the exterior of the mold cavities through which air is directed. The mold sections may include radially and axially extending ribs that extend into the cooling channel, and shells that enclose the ribs and surround the entire perimeter of the mold sections to define the cooling channels between the shell and mold section. However, the space between adjacent mold cavities is limited and the size of the mold sections is increased with the cooling shells disposed around them, so the size of the articles of glassware that can be molded in a given mold layout or IS machine, is limited.

### SUMMARY OF THE INVENTION

A mold for a glassware forming machine includes a pair of mold segments each having a central portion and laterally spaced edge portions adapted to be brought together at the edge portions to form a mold cavity. A coolant shell is externally mounted over the central portion of each mold segment to form a cooling cavity between the coolant shell and the central portion of the mold segment, and the coolant shells do not extend into the edge portion of the mold segments. Coolant passages separate from the cooling cavities extend axially through the edge portions of the mold segments to facilitate cooling the edge portions in use.

In one presently preferred embodiment, the coolant passages are formed on either side of a parting line of a mold cavity defined by the mold segments. The coolant passages help cool the molds in the area of the parting line where adequate cooling might not be achieved by way of air flow through the cooling cavity which is spaced from the area of the parting line. Accordingly, the coolant passages and coolant cavity provide more even cooling of the mold in use to improve product quality and consistency.

### BRIEF DESCRIPTION OF THE DRAWINGS

These and other objects, features, advantages and aspects of the present invention will be apparent from the following detailed description of the preferred embodiments and best mode, appended claims and accompanying drawings in which:

FIG. 1 is a perspective view of a portion of a mold assembly according to one presently preferred embodiment of the invention showing one mold segment carried by a base assembly;

FIG. 2 is a bottom view of a cover plate of the base assembly shown with a mold segment mounted thereon;

FIG. 3 is a cross-sectional view taken generally along the line 3-3 of FIG. 2, and

FIG. 4 is a cross-sectional view taken generally along the line 4-4 of FIG. 2.

### DETAILED DESCRIPTION OF THE PREFERRED EMBODIMENTS

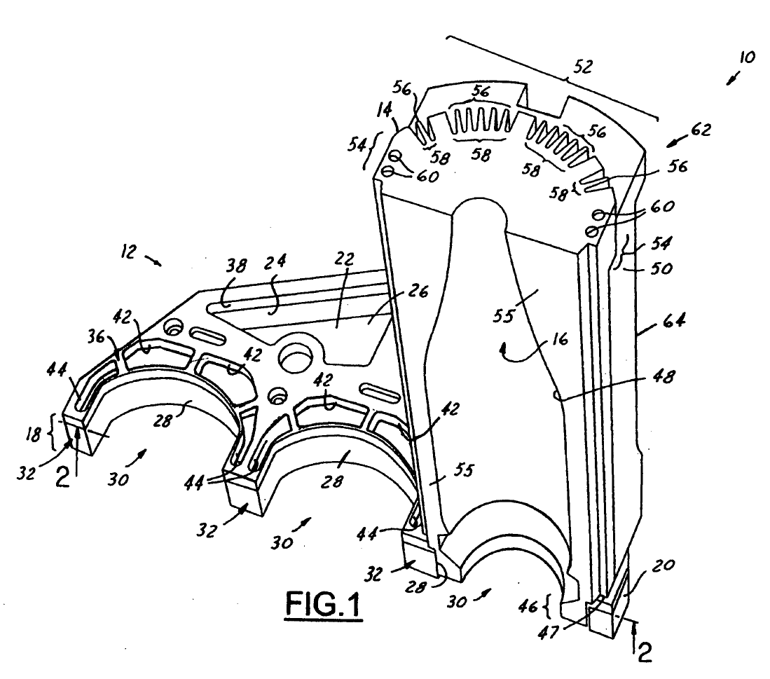

Referring in more detail to the drawings, FIG. 1 shows one mold segment 14 constructed according to one presently preferred embodiment of the invention and mounted on a base assembly 12 for use in an IS glassware forming machine (not shown). The base assembly 12 shown is constructed to receive three mold segments, although only one is shown mounted thereon so that more of the base assembly can be seen. In use, two base assemblies 12 are provided in the IS machine, each having three mold segments 14 mounted thereon. The base assemblies 12 and mold segments are complementary in shape so that when they are mated together, three mold cavities are defined with one cavity between each of the three pairs of mated mold segments 14. Each mold segment 14 is preferably part of a mold assembly 10 that includes a cooling system to cool the mold segments 14 in use. The molds may be blow molds or blank molds used to initially form a glass gob into a glass blank that is then transferred to a blow mold for molding into an article of glassware, such as a glass container, as is known in the art.

The base assembly 12 has a base plate 20 with a bottom wall 22 and a peripheral sidewall 24 extending upwardly from the bottom wall 22 to define part of a chamber 26. The base plate 20 preferably has a plurality of recessed pockets 28 adjacent one another to define mold segment receptacles 30. The receptacles 30 are separated in part from one another along their edges by fingers 32. The fingers 32 have end surfaces 34 arranged for abutment with fingers 32 on the other base assembly (not shown) when the mold segments 14 are closed together to define the mold cavities between them. The chamber 26 preferably extends into the fingers 32.

The base assembly 12 also has a cover plate 36 disposed on the base plate 20 overlying the sidewall 24 and thereby enclosing and defining part of the chamber 26. The cover plate 36 has at least one, and preferably a pair of inlet openings 38 arranged for communication with an air chamber or plenum 40 (FIG. 4), thereby providing a path for air flow into the chamber 26. The plenum 40 is preferably communicated with a source of pressurized air (not shown), such as a pressurized air line within a plant, or a separate air compressor, as is known. The cover plate 36 has at least one, and preferably a pair of central outlet openings 42 for each mold segment on the base assembly 12. The openings 42 extend through the cover plate so that they are open to the chamber 26 to communicate the chamber 26 with the mold segments 14 mounted on the base assembly 12. A portion of the cover plate 36 overlying the fingers 32 also has at least one outlet opening, represented here by way of example and without limitations, as slots 44, to further communicate the chamber 26 with the mold segments 14. Two slots 44 preferably are provided adjacent to each receptacle 30 with one slot 44 adjacent the finger 32 on each side of each receptacle 30. In this manner, the slots are adjacent to the end surfaces 34 and generally adjacent to the parting line in a mold cavity defined by the mold segments 14.

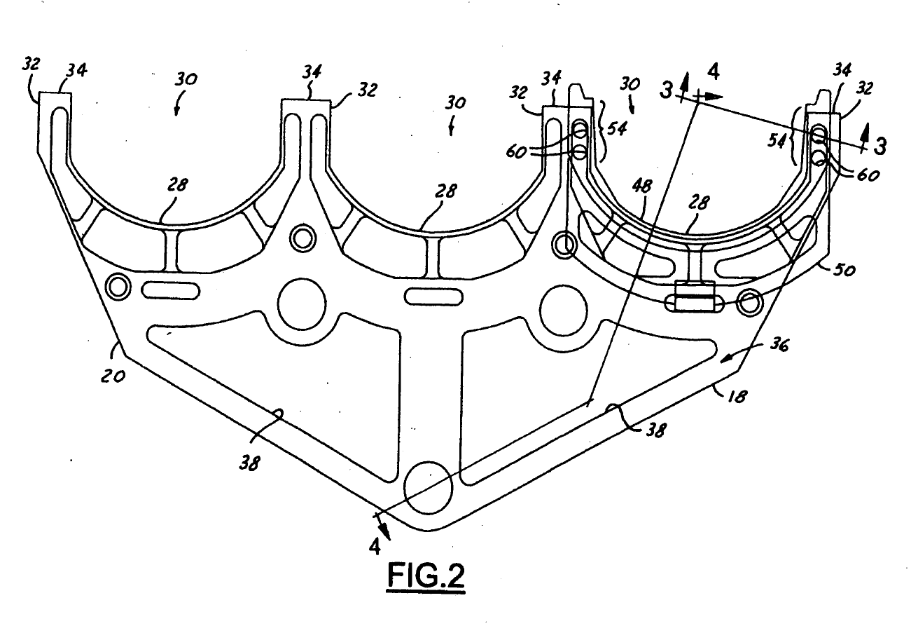

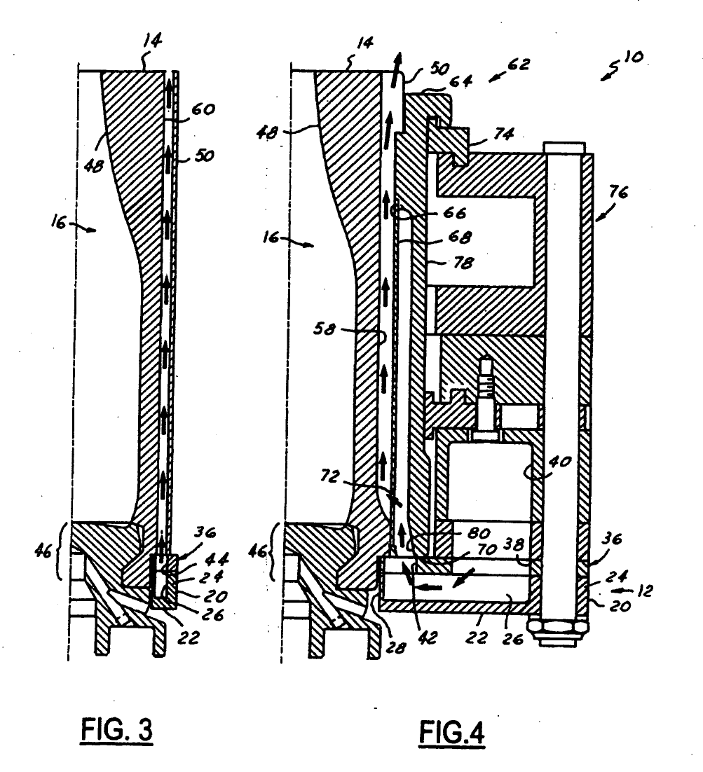

The mold segments 14 have a reduced diameter lower portion 46 sized for receipt within the receptacles 30 of the base assembly 12, and providing an outwardly extending support surface 47 that in assembly is received on the cover plate 36. As best shown in FIG. 1, each mold segment 14 has an inner mold surface 48 and an outer surface 50 with a central portion 52 extending between laterally spaced edge protons 54 that overlie the fingers 32 of the base assembly 12. The edge portions 54 of each mold segment 14 have corresponding end faces 55 that are adapted to be brought into mating contact with end faces of a mating mold segment 14 (not shown) to define the mold cavity 16 between the mold surfaces 48 of the mated mold segments 14. A plurality of axially extending fins or ribs 56 extend radially outwardly from the central portion 52 of each mold segment 14 to define at least in part cooling cavity 58 which may be generally open or include a plurality of generally separate cooling channels that collectively define a cooling cavity. The ribs 56 preferably span the central portion 52, but preferably do not extend into the edge portions 54. As shown in FIG. 4, the cooling cavity or cavities 58 are arranged for communication with the central outlet openings 42 in the cover plate 36 when a mold segment 14 is mounted on the base assembly 12. Each mold segment edge portion 54 has at least one, and preferably a pair of coolant passages 60 extending axially therethrough and circumferentially spaced or offset from the adjacent cooling cavity 58. The coolant passages 60 preferably do not communicate directly with the cooling cavity 58. Preferably, the coolant passages 60 are drilled holes extending axially through the mold segments and are open at their ends but otherwise completely enclosed by the edge portions 54 so that air flows from one end to the other in each passage 60. The coolant passages 60 are also preferably spaced and separate from one another so that air flow through the passages 60 cools different portions of the mold segment 14. As shown in FIGS. 2 and 3, the coolant passages 60 are arranged for communication with the slots 44 in the cover plate 36 when a mold segment 14 is mounted on the base assembly 12.

As shown in FIG. 4, a separate cooling jacket assembly 62 is disposed about the central portion 52 of each mold segment 14. Each cooling jacket assembly 62 includes a coolant shell 68 and a shell holder 64. The shell holder 64 is carried by the base assembly 12, and the shell 68 is carried by and disposed, such as by a press-fit, within a recess or channel in the holder 64. The shell 68 overlies the ribs 56 and defines part of the cooling cavity or channels 58. The shell holder 64 has a bottom surface 70 that engages the cover plate 36 and has an opening or slot 80 overlying the central outlet openings 42 and communicated with the chamber 26. The coolant shell 68 is positioned radially inwardly from the outlet openings 42, and has at least one opening 72 that provides a flow path for coolant into the cooling channels 58 between the coolant shell 68 and the ribs 56. The shell holder 64 and coolant shell 68 do not extend beyond the central portion 52 into the edge portion 54 of the mold segment 14, thereby minimizing the diameter of each mold assembly 10. Preferably, the shell 68 and fins 56 span not more than about 130 degrees of the exterior of the mold segments 14. For example, the shell 68 and fins 56 may span between about 100 degrees to 130 degrees of the exterior of the mold segments.

The sleeve 64 preferably has an upper outwardly extending lip 74 to facilitate attaching an arm assembly 76 (FIG. 4) to an outer portion 78 of the sleeve 64. The arm assembly 76 defines in part the plenum 40 that is communicated with an air source and directs air through the inlet openings 38 in the cover plate 36 and into the chamber 26 of the base assembly 12. The plenum 40 could be communicated for coolant flow with the chamber 26 other than as shown here, such as, by way of example and without limitation, by arranging the plenum beneath the base assembly (not shown) and channeling the pressurized air through an opening in the bottom wall 22 or sidewall 24 of the base plate 20 directly into the chamber 26, or otherwise, as desired.

In operation, opposed pairs of mold segments 14 are moved toward one another until their respective end faces 55 are mated to define a mold cavity 16 between the mold segments 14 in which a glass gob is received and formed into the shape of the mold cavity 16. To improve cooling of the mold segments, a coolant, such as air, flows through the plenum 40, into the chamber 26, and out the outlet 42 and slots 44 in the base assembly 12. From the outlets 42, air flows through the slot 80 in holder 64, through the opening 72 in shell 68, and into and through the cooling cavities 58. From the slots 44, air flows into and through the coolant passages 60.

The edge portions 54 preferably require a relatively small amount of lateral space to accommodate the coolant passages 60. Also, since the shell 68 and holder 64 do not extend around the edge portions 54, larger mold segments and mold cavities can be used in a given IS machine to produce larger articles of glassware with that machine.

It should be recognized that upon reading the disclosure herein, one ordinarily skilled in the art would readily recognize embodiments other than those disclosed herein, with those embodiments being within the scope of the claims that follow. For example, rather than using a single plenum to provide air flow through the associated cooling cavity and through the passages, separate plenums or sources of air and/or other fluid could be used to direct the coolant through the cooling cavities 58 and the coolant passages 60 of the segments 14. Also, the shell 68 may be trapped between the mold segment 14 and holder 64 or otherwise disposed between them and adjacent to the mold segment 14. Accordingly, this disclosure herein is intended to be exemplary, and not limiting. The scope of the invention is defined by the following claims.

What is claimed is:

1. A mold for a glassware forming machine, which includes:
a pair of mold segments, each having a central portion and laterally spaced edge portions, said mold segments being adapted to be brought together at said edge portions to form a mold cavity;
a pair of coolant shells each disposed adjacent to an associated mold segment over said central portion of said mold segment to form a cooling cavity between said shell and said central portion of said mold segment, said shells and said cooling cavities not extending into said edge portion of said mold segments; and
coolant passages separate from said cooling cavities extending axially through said mold segments at said edge portions of said mold segments.

2. The mold of claim 1 wherein said central portions have radially outwardly extending ribs that extend axially along at least a portion of said central portions to define in part said cooling cavities.

3. The mold of claim 2 wherein said ribs are not formed in said edge portions.

4. The mold of claim 1 wherein each shell spans not more than about 130 degrees of the periphery of its associated mold segment.

5. The mold of claim 1 wherein each cooling cavity extends between about 100 to 130 degrees of the periphery of its associated mold segment.

6. The mold of claim 1 wherein each cooling cavity extends not more than about 130 degrees of the periphery of its associated mold segment.

7. The mold of claim 1 wherein each cooling cavity extends between about 100 to 130 degrees of the periphery of its associated mold segment.

8. The mold of claim 1 wherein each edge portion has an end face adapted to engage an end face of a mating mold segment, and each coolant passage is generally adjacent to an end face.

9. The mold of claim 8 wherein each coolant passage is spaced inwardly from and is not open to its adjacent end face.

10. The mold of claim 1 wherein each edge portion has at least one coolant passage formed therein.

11. A mold for a glassware forming machine, which includes:
a pair of mold segments, each having a central portion and laterally spaced edge portions, said mold segments being adapted to be brought together at said edge portions to form a mold cavity;
a pair of coolant shells each externally mounted to an associated mold segment over said central portion of said mold segment to form a cooling cavity between said shell and said central portion of said mold segment, said shells and said cooling cavities extending not more than about 130 degrees about the periphery of the mold segment but not extending into said edge portion of said mold segments; and
coolant passages separate from said cooling cavities extending axially through said mold segments with at least one cooling passage formed in each of said edge portions of said mold segments.

12. The mold of claim 11 wherein said coolant passages are enclosed by said edge portions.

13. A method of cooling a glassware mold that has a pair of mold segments each having a central portion that defines part of a cooling cavity and laterally spaced edge portions separate from the central portion with at least one coolant passage in said edge portions, and the mold segments being adapted to be brought together at said edge portions to define a mold cavity, said method including the steps of:
providing coolant into said cooling cavities and against said central portions; and
providing coolant into said coolant passages to cool said edge portions.

14. The method set forth in claim 13 wherein each mold segment further includes a coolant shell disposed over said central portion of said mold segment to define part of the cooling cavity between said shell and said central portion of said mold segment, and said step of providing coolant in said cooling cavity includes directing air between said central portion and said shell.

15. The method of claim 13 wherein said coolant passages extend through said mold segments, and said step of providing coolant into said coolant passages includes moving air into and through the coolant passages.
